(19) United States
(12) Patent Application Publication
(10) Pub. No.: US 2021/0354256 A1
(43) Pub. Date: Nov. 18, 2021

(54) ROBOTIC ASSEMBLY METHOD

(71) Applicant: ABB SCHWEIZ AG, Baden (CH)

(72) Inventor: Bernard NEGRE, Paris (FR)

(21) Appl. No.: 16/634,810

(22) PCT Filed: Jul. 28, 2017
(86) PCT No.: PCT/EP2017/069226

§ 371 Date: Jan. 28, 2020

(51) Int. Cl. B23P 21/00

(52) U.S. Cl. CPC B23P 21/004

(57) ABSTRACT

The invention relates to a method for assembling a product or portion of a product (10), on an assembly site (SA), comprising an assembly line (LA), the assembly line comprising a plurality of assembly stations (S1, S2, S3, etc.) and at least one mobile platform (PMA, PMB, etc.), the method comprising the following steps applied to each mobile platform of the at least one mobile platform (PMA, PMB, etc.): h) loading on the mobile platform (PMA, PMB, etc.) a plurality of objects, comprising one or more elementary parts (P1A, P2A, P3A, P4, P5, P6, etc.) and/or one or more partial assemblies (AP1, AP2, . . . APi) constituting the product to be assembled or a portion of the product to be assembled on the assembly line (LA); i) moving the mobile platform (PMA, PMB, etc.) to an assembly station of the plurality of assembly stations (S1, S2, S3, etc.) of the assembly line (LA); j) transferring onto the assembly station one or more objects of the plurality of objects present on the mobile platform (PMA, PMB, etc.); k) modifying or assembling the one or more objects transferred in step c), so as to constitute an intermediate object; I) transferring onto the mobile platform (PMA, PMB, etc.) the intermediate object constituted in the preceding step, so that, for the subsequent steps of the method, the object or said plurality of objects transferred in step c) are replaced in the plurality of objects with the intermediate object constituted in step d); m) repeating steps b) to e) so that the platform moves consecutively from an assembly station, at which an intermediate object is constituted, to another station, at which another intermediate object is constituted.

### CROSS REFERENCE TO RELATED APPLICATIONS

This application is a National Stage of PCT Application No. PCT/EP2017/069226 filed on Jul. 28, 2017, the contents of which is incorporated herein by reference thereto.

### TECHNICAL FIELD

The present invention concerns the field of robotic assembly methods.

### BACKGROUND

It is known to organize an assembly plant in assembly lines or areas, to ensure the assembly of all or part of a manufactured product. These assembly lines or areas comprise a set of intermediate assembly stations, each corresponding to different steps of assembly of the complete product. Each assembly station is supplied with batches or a subset of constituting parts of the product to be manufactured, each part of a batch having to be assembled with a part of another batch, this assembly leading to an intermediate or partial assembly. A part of a batch may also be intended to be assembled for an intermediate or partial assembly. The parts or the intermediate or partial assemblies to be assembled are temporarily stored in lockers stationed in the proximity of the concerned assembly station. The lockers can contain only but a limited number of copies of each object, part, or partial or intermediate assembly, to be assembled, depending on the size of these objects and of the lockers. The lockers are transported up to the assembly stations by lifting equipment, trains, or robotic vehicles. The parts are then loaded into the assembly station by operators, manually, or else automatically thanks to handling robots which take the parts directly in the lockers stationed near the station.

FIG. 1 schematically represents the operation of an assembly line LA according to the known prior art. Thus, there is represented an assembly line LA comprising 3 assembly stations S1, S2, S3, each assembly station being dedicated to the assembly of some objects, elementary parts or partial assemblies, constituting a given product. The assembly station S1 is dedicated to the assembly of the parts P1A, P2A, and P3A; the assembly station S2 is dedicated to the assembly of the intermediate assembly AI1=(P1A+P2A+P3A) with the parts P4 and P5. The lockers C1 and C2 have been positioned in the proximity of the station S1, after having been loaded respectively with batches of parts P1, on the one hand, and batches of pieces P2 and P3, on the other hand. The parts P1A, P2A, and P3A are transferred from the lockers C1 and C2 to the station S1 which can then proceed with the assembly of these parts. This assembly gives rise to an intermediate assembly AI1 which is conveyed to the next station S2 so that it completes this intermediate assembly with the parts P4 and P5. An assembly station can also receive, via the lockers, partial assemblies originating from another assembly line; for example, as represented in FIG. 1, the station S3 receives, via the locker C3, a batch of parts P6 and a batch of partial assemblies AP, originating from another assembly line; these partial assemblies are intended to be completed on the station S3, each with a part P6, on the one hand, and with an intermediate assembly AI2 conveyed from the station S2, constituted by the parts P1A+P2A+P3A+P4+P5 assembled successively on S1 then on S2.

The assembly line LA may also target the assembly of several different models of the same product; thus, on the first station, the parts P1A, P2A and P3A are intended to assemble the model A, whereas the parts P1B, P2B, and P3B are intended to assemble the parts of another model B of the product. As illustrated in FIG. 1, the lockers must be loaded beforehand so that the parts to be assembled of the same model are simultaneously transferred to the station, avoiding being in the situation where a part of a model A is transferred from a locker C1 to be assembled with a part of a model B originating from the locker C2.

The method according to the prior art therefore requires the preparation of different batches of elementary parts P1, P2, . . . Pi and/or partial assemblies AP1, AP2, . . . APi stored in lockers, these lockers being positioned in the proximity of different assembly stations S1, S2, . . . Si, depending on the programmed scheduling of the assembly operations. The intermediate assemblies produced on an assembly station are conveyed from one station to another on the same assembly line, to be completed therein, and may also be positioned in a locker intended for a station of another assembly line.

The assembly lines thus constituted implement many different means for conveying the parts, from the storage warehouses to the assembly stations, and from an assembly station to the next assembly station of the assembly chain. On the other hand, it is often very difficult to adapt the lockers to the very different shapes of the parts, corresponding to different models, which must be arranged in the same locker. The arrangement of the stations is constrained by the conveying devices to be arranged therebetween. This results in a complex programming of the succession of assembly steps and a very complex logistics management of the flow of parts and intermediate or partial assemblies.

### BRIEF SUMMARY

The invention therefore aims at proposing a solution to all or part of these problems.

To this end, the present invention concerns a method for assembling a product or a portion of a product, on an assembly site, comprising an assembly line, the assembly line comprising a plurality of assembly stations and at least one movable platform, the method comprising the following steps applied to each movable platform of the at least one movable platform:

a) Loading on the movable platform a plurality of objects, comprising one or several elementary part(s) and/or one or several partial assembly(assemblies) constituting the product to be assembled or a portion of the product to be assembled on the assembly line,

b) Displacing the movable platform up to an assembly station of the plurality of assembly stations of the assembly line;

c) transferring on the assembly station one or several object(s) of the plurality of objects present on the movable platform;

d) modifying, or assembling the object(s) transferred at step c), so as to constitute an intermediate object;

e) transferring on the movable platform the intermediate object constituted in the previous step, such that, for the following steps of the method, the object or said several objects transferred at step c) are replaced in the plurality of objects by the intermediate object constituted at step d);

f) repeating steps b) to e) so that the platform is successively displaced from an assembly station, where an intermediate object is constituted, to another station, where another intermediate object is constituted.

According to one aspect of the invention, a conveyance of the plurality of elementary parts and partial assemblies for the assembly of a product or portion of a product is ensured by one single movable platform which is displaced from an assembly station to the other assembly station.

According to an aspect of the invention, a series of movable platforms ensures the conveying for the assembly of one or several different model(s) of a product.

Thanks to these arrangements, the management of the logistics flow associated to the operation of the production line is considerably simplified. In particular, it is no longer necessary to manage the consistency, between different lockers, of the stacks of different parts, intended for assembling different models of a product.

According to one aspect of the invention, step a) is preceded by a step a0) of configuring each movable platform of the at least one movable platform.

According to one aspect of the invention, step a) is followed by a step a1) of automated check-up of the loading of each movable platform of the at least one movable platform.

Thanks to these arrangements, the loading of the at least one movable platform is adapted for assembling, on the assembly line, the product or a portion of the product, or a model of the product or a portion of a model of the product.

According to one aspect of the invention, the assembly site comprises a plurality of assembly lines, each dedicated to the assembly of one or several partial assembly(assemblies) of the product or a portion of a product, the method comprising the following additional steps, carried out before step b):

aa) displacing a movable platform from the at least one movable platform up to an assembly line of the plurality of assembly lines;

ab) checking up the loading of the movable platform and, depending on the result of this check-up, configuring the movable platform and completing the loading present on the movable platform such that it carries a plurality of objects, constituting the product to be assembled or the portion of the product to be assembled on the assembly line;

and the method comprising the following additional step, carried out following step f):

g) repeating steps aa), ab), b) to f) so that the movable platform is successively displaced from an assembly line on which at least one partial assembly is assembled to another assembly line on which another partial assembly is assembled.

Thanks to these arrangements, one single movable platform, which is displaced between the different stations of the same assembly line then of another assembly line, ensures the conveying of the objects of the plurality of objects until the product is partially or completely assembled.

According to one aspect of the invention, the at least one movable platform is displaced by an autonomous vehicle driven by a programmed system.

Thanks to these arrangements, the manufacturing line may be implanted in a very flexible manner.

According to one aspect of the invention, the at least one movable platform carries at least one handling robot to carry out at least one portion of steps a), and/or c), and/or e) of the method.

Thanks to these arrangements, the automation of the manufacturing line is made more complete.

According to one aspect of the invention, the at least one movable platform comprises an electronic memory, accessible in writing and reading successively by each assembly station of the plurality of assembly stations, said electronic memory containing information relating to the product or to the portion of a product to be assembled and/or to the objects of the plurality of objects loaded on the at least one movable platform, said information being used and updated by each assembly station of the plurality of assembly stations.

According to one aspect of the invention, step a1) of automated check-up of the loading of the movable platform comprises a reading of the content of the electronic memory of the movable platform.

Thanks to these arrangements, monitoring the progress of the assembly method is simplified.

According to one aspect of the invention, the assembled product is a motor vehicle.

The invention also concerns an installation for assembling a product, or a portion of a product, comprising at least one assembly line, each assembly line of the at least one assembly line comprising a plurality of assembly stations and at least one movable platform, the steps of the method according to the invention being applied to each movable platform of the at least one movable platform.

### BRIEF DESCRIPTION OF THE DRAWINGS

For good understanding, the invention is described with reference to the appended drawings representing, as a non-limiting example, an embodiment of a method according to the invention.

FIG. 1 is a schematic representation of the operation of an assembly line according to the prior art.

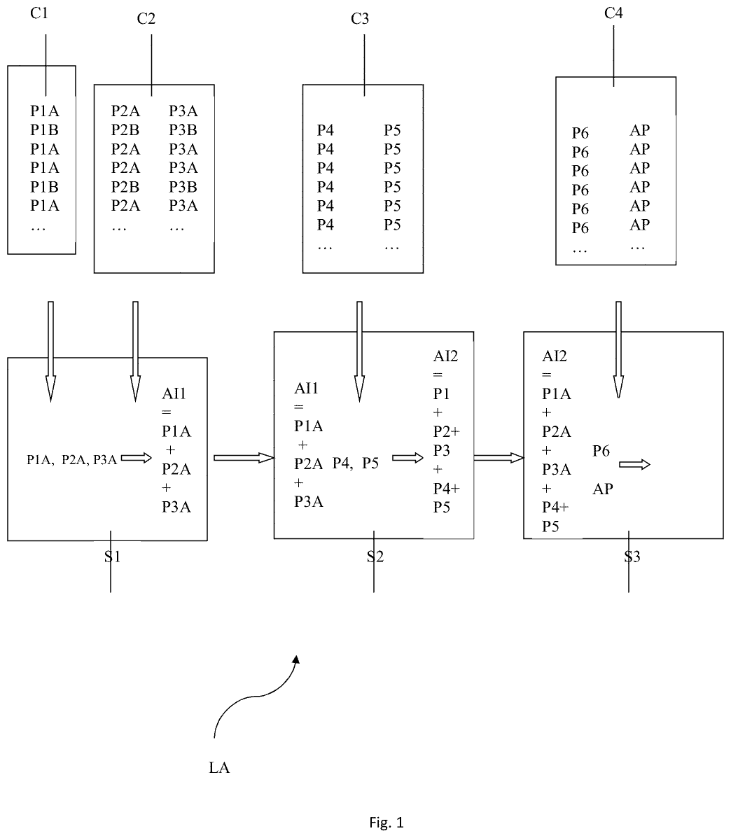

FIG. 2 is a schematic representation of the operation of an assembly line according to the invention.

FIGS. 3a, 3b, 3c, 3d illustrate the step of configuring the movable platform which precedes the step of loading the movable platform.

FIG. 4 represents the different steps of the method on an assembly site with two assembly lines, and a series of movable platforms.

FIG. 5 represents a movable platform with its load of parts.

FIG. 6 represents a movable platform with a partial assembly.

### DETAILED DESCRIPTION

In the following description, the following conventions are used:

An elementary part is an object that results neither from a prior assembly, nor from a modification within the meaning defined below.

A modification of an elementary part, or of an intermediate or partial assembly, is the automatic addition of a simple component, for example a screw or a nut, or of any other element which is not taken on a movable platform; in this case the simple component or the added element is prepositioned on the assembly station. A modification may also be a deformation or a transformation, for example crimping, gluing, painting, or any other transformation, of a part or an intermediate assembly, carried out on the station without adding a complementary part, a simple component or any other element not taken on the platform. A modification may finally be a combination, carried out on the station, of the addition of a simple component or of any other element not taken on the platform and of a deformation or a transformation.

An intermediate object is an object which results from at least one modification and/or from at least one intermediate assembly, the modification(s) of an object and/or of at least one intermediate assembly having been carried out on an assembly station of the considered assembly line.

An intermediate assembly is an object which results from a prior assembly of at least two objects on an assembly station of the considered assembly line; an intermediate assembly does not result from a simple modification of an object.

The term «intermediate assembly» will preferably be reserved to designate an object which results exclusively from the prior assembly of two objects on the considered assembly line.

A partial assembly is an object which results from at least one prior assembly with other objects on an assembly station of an assembly line other than the considered assembly line.

The reference numerals in the drawings, AI, AI1, AI2, . . . might designate intermediate assemblies or intermediate objects, whereas the reference numerals AP, AP1, AP2, . . . will preferably designate partial assemblies.

An assembly line is constituted by one or several assembly station(s). This (or these) assembly station(s) are not necessarily aligned. The system for displacing the movable platforms may allow circulating from one station to another in a very flexible manner in terms of positioning in the workshop. PMA, PMB . . . designates respectively a platform configured to transport the objects or assembly(assemblies) of the product A and respectively the product B. A movable platform PMA may become a movable platform PMB, . . . following the configuration made at step a0).

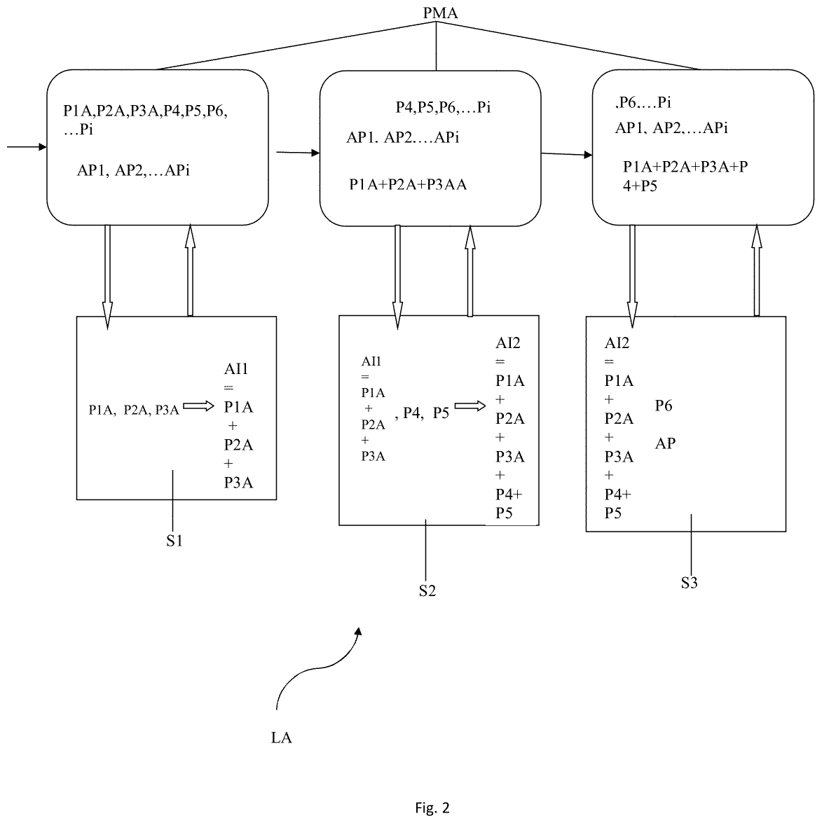

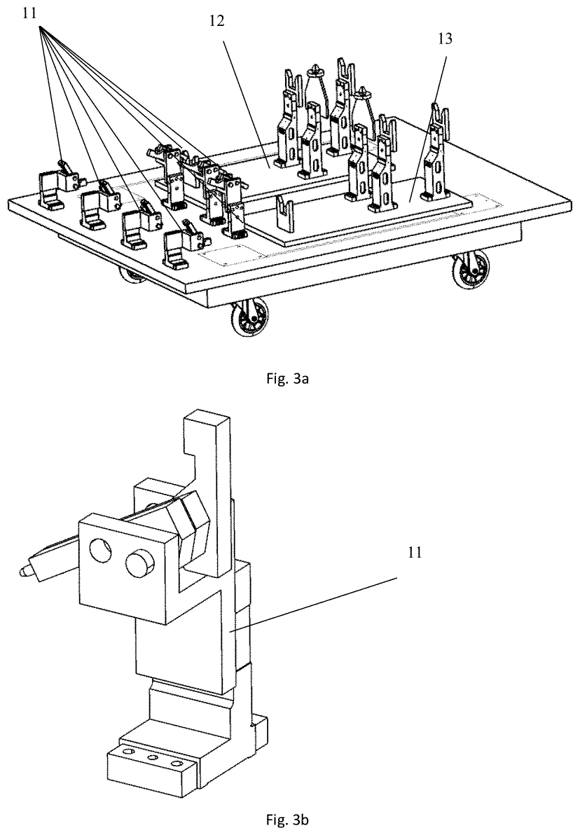

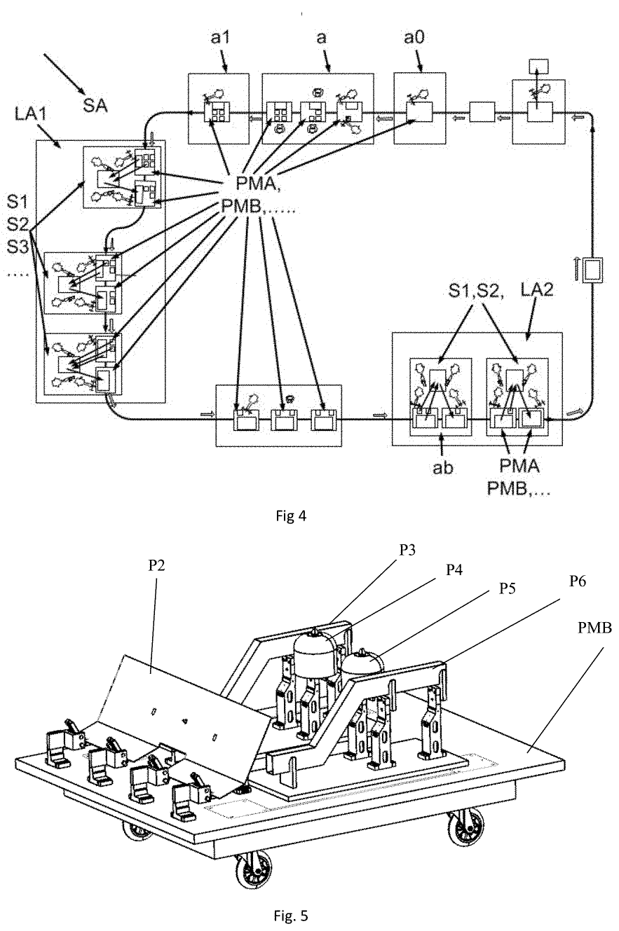

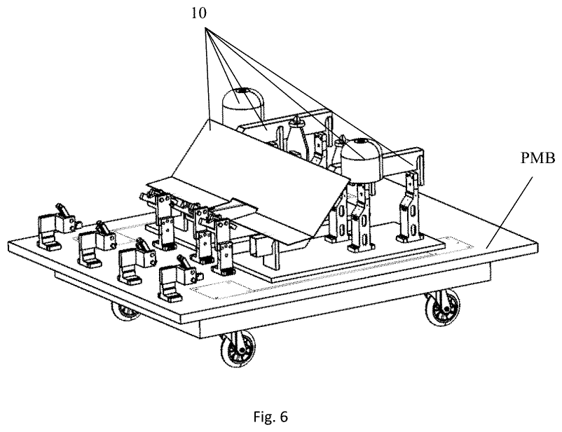

FIG. 2 represents the operating mode of an assembly line LA according to an implementation of the method according to the invention. Instead of the different lockers C1, C2, C3, etc. known in the prior art for positioning batches of parts to be assembled in the proximity of the assembly stations, in the method according to the invention, a series of movable platforms PMA, PMB, . . . circulate from an assembly station to an assembly station. In FIG. 2, only one station PMA is represented. At the beginning of the method, each movable platform PMA, PMB, . . . is configured so as to carry all the constituent objects of the product or the portion of the product, to be assembled on the considered assembly line LA, as represented in FIG. 3d; A movable platform PMA carries all of the constituent objects P1A, P2A, P3, P4, P5, P6 of the product or the portion of the product according to the model A of said product, whereas the movable platform PMB, represented in FIG. 5 carries all of the constituent objects of the product or the portion of the product according to the model B. FIG. 6 schematically represents the partial or intermediate assembly 10 obtained from the assembly of the objects loaded and present on the movable platform PMB, as represented in FIG. 5. Thus, the loading of a movable platform is dedicated to a product, or to a portion of a product, or else to a model of a product, or else to a portion of a model of a product. The loading of each movable platform PMA at the beginning of the method implemented on this assembly line LA may comprise a plurality of objects, comprising, on the one hand, one or several elementary part(s) P1A, P2A, P3A, P4 . . . , Pi, but also one or several partial assembly(assemblies) AP, AP2, . . . APi, originating from other assembly lines. Each movable platform PMA, PMB, . . . may, as previously indicated, be loaded manually or automatically, for example by robots, with a plurality of objects different from one platform to another. During the execution of the method on this assembly line, each movable platform PMA, PMB, may temporarily carry other assemblies, called intermediate assemblies, AI; an intermediate assembly AI has been carried out from objects (elementary parts and/or partial assemblies) taken manually or automatically, for example by robots, on this same movable platform PMA, PMB, . . . on which the intermediate assembly is placed manually or automatically, for example by robots, immediately after it has been carried out; in this case, before the objects to be assembled are taken to constitute said intermediate assembly, the plurality of objects present on the movable platform PMA, PMB, . . . comprises said objects, and after said intermediate assembly has been formed and placed on the movable platform PMA, PMB, . . . , said plurality of objects present on said movable platform PMA, PMB, . . . no longer comprises said objects but comprises said intermediate assembly AI constituted by said objects; the position of said intermediate assembly AI on said movable platform PMA, PMB, . . . , may be identical for some objects of said assembly but is generally different from the position of said objects which have been assembled to constitute said intermediate assembly AI. Thus, within the meaning indicated above, said assembled objects are replaced by said intermediate assembly AI in the plurality of objects present on the movable platform PMA, PMB, for example, in FIG. 5 a plurality of objects P2, P3, P4, P5, P6 have been loaded and are present on the movable platform PMB; in FIG. 6, the objects P2, P3, P4, P5, P6 have been assembled and the intermediate assembly 10 thus constituted has replaced the objects P2, P3, P4, P5, P6 in the plurality of objects, which is then constituted by only but one intermediate object 10.

An intermediate object AI may also result from a modification, within the meaning specified above, of an elementary part, or of an intermediate or partial assembly, taken from this same movable platform PMA, PMB, . . . on which it will be placed immediately after said modification has been carried out, without, herein again, its position on said movable platform PMA, PMB, . . . necessarily being the same as that of the object taken before its modification. Thus, the modified intermediate object AI will replace, in the plurality of objects present on the movable platform PMA, PMB, . . . , the intermediate assembly AI initially present in this plurality of objects before it is modified, within the meaning indicated above.

The assembly line LA comprises a series of movable platforms and a plurality of assembly stations S1, S2, S3 . . . . Each assembly station is configured to enable:
an assembly of two or several elementary part(s) P1, P2, . . . , Pi, taken manually or automatically, for example by one or several robot(s), on a movable platform PMA, PMB, . . . or
an assembly of one or several elementary part(s) P1, P2, . . . , Pi, with one or several object(s) or intermediate AI, AI1, AI2 . . . , or partial AP, AP1, AP2, . . . APi, assembly(assemblies) taken manually or automatically, for example by one or several robot(s), on a movable platform PMA, PMB, . . . , or,
a modification, within the meaning defined above, of an elementary part, an intermediate object, or an intermediate or partial assembly, taken manually or automatically, for example by one or several robot(s), on a movable platform PMA, PMB, . . . .

Each assembly line is thus configured to assemble a product or a variety of particular models A, B, . . . of a product or a variety of products, or else a portion of a product or a model of a product.

The first step a) of the method according to the invention, for assembling a product or a particular model A, B, . . . of a product, or else a portion of a product or model of a product, comprises three sub-steps of:
configuring a movable platform PMA, PMB,
loading manually or automatically, for example by one or several robot(s), a movable platform PMA, PMB, . . . with the plurality of objects required for the assembly, on one or several assembly line(s) LA, of the product or a model A, B, . . . of the product, or a portion of the product or a model of the product
automatically checking up after loading the movable platform PMA, PMB, . . . , the compliance of the loading with the product or the particular model A, B, . . . of the product, or else with the portion of the product or with the portion of the model of the product to be assembled.

An embodiment of the first sub-step of configuring, then of loading a movable platform PMA, PMB, . . . is illustrated, as example, in FIGS. 3a to 3d. The configuration of the platform consists in positioning on the movable platform PMA, PMB, . . . some support elements which will then receive the parts or intermediate or partial assemblies during the following steps of the method. Thus, in the example represented in FIG. 3a, support elements 11 are represented on the movable platform PMA, PMB, . . . , one of which is represented in particular, as example, in the following FIGS. 3b and 3c. This particular support element is provided with notched extensions movable in rotation; FIG. 3b shows an angular position of these notched extensions, and FIG. 3c shows another one. An appropriate angular positioning of these notched extensions on each of the 4 support elements present on this movable platform, thus allows preparing the movable platform to receive some particular parts, such as for example the parts P1A and P2A loaded on the movable platform PMA represented in FIG. 3d, or the part P2 loaded on the movable platform PMB represented in FIG. 5. Another example of configuration of a movable platform PMA, PMB, . . . , is also illustrated in FIG. 3a, consists in positioning on a movable platform PMA, PMB, . . . , one or several modular sub-assemblies 12, 13 each comprising one or several support(s) securely fastened to an interface, for example, a plate, this interface being able to be positioned, in a sufficiently accurate manner, on the platform to ensure a positioning of the objects such that it is possible to automatically load and unload them. These modules 12, 13 can be changed depending on the model to be assembled.

The check-up sub-step consists of a visual or automated inspection, for example by one or several robot(s) equipped with sensors, with for example a digital camera and a processing by automated comparison of the digital images with a standard loading model of the movable platform PMA, PMB, . . . , in order to ensure that it carries all the parts or partial assemblies necessary for the assembly of a product or a particular model A, B, . . . of a product, or else a portion of a product or a model of a product.

The platform may also be equipped, for example, with an electronic memory system, accessible in writing and reading allowing memorizing and identifying the nature of the product to be assembled from the different objects that have been loaded on the platform, as well as information on the progress of the assembly stages, or qualitative validation information, etc. For this purpose, the different assembly stations may be equipped with a read-write system allowing updating the content of the electronic memory of the platform. This device allows ensuring, in an extremely simple manner, the monitoring of the assembly process. This monitoring function is very complicated to implement in the state of the prior art as previously described, because the objects constituting the product to be assembled are distributed between different lockers and these objects do not individually include a memory system; thus in the state of the prior art, only the automaton for managing the overall process allows ensuring this monitoring through very complex programming.

After this first step of configuring, loading, and checking up the loading of the movable platform PMA, PMB, . . . , for the product or the particular model A, B, . . . of the product, or else for the portion of the product or the portion of the model of the product to be assembled, the method according to the invention continues with the following steps of:

b) displacing the platform up to a station of the plurality of stations;

c) transferring manually or automatically, for example by one or several robot(s), on the station, an object or at least two objects of the plurality of objects present on the platform;

d) modifying the object or assembling the at least two objects transferred in the previous step, so as to constitute an intermediate object;

e) transferring manually or automatically, for example by one or several robot(s), on the movable platform, the intermediate object constituted in the previous step, such that, for the following steps of the method, the object or the at least two objects transferred at step c) are replaced in the plurality of objects, within the meaning indicated above, by the intermediate object constituted at step d);

f) repeating steps b) to e) so that the platform is successively displaced from one station, where an intermediate object is constituted, to another station, where another intermediate object is constituted, until the movable platform has passed through all the stations of the assembly line, or until the assembly of the product or of the portion of the product which was to be assembled on this assembly line is completed.

At this stage of the method according to the invention, the result of the assembly may consist of one or several partial assembly(assemblies).

According to one aspect of the invention, the method allows completing the partial assembly carried out on this assembly line LA, by displacing the movable platform PMA, PMB, . . . , to another assembly line LAi, after having, where necessary, according to the first step a) of the method, reconfigured the movable platform PMA, PMB, . . . , then, where appropriate, loaded the latter with a new plurality of objects, intended to be assembled with the partial assembly(assemblies) obtained on the previous assembly line LA. In some cases, the partial assemblies obtained on the previous assembly line LA will not necessarily need to be completed for the rest of the method implemented on the following assembly line LAi.

On the assembly line LAi, steps b) to f) of the method are then implemented.

The assembly site may thus comprise several assembly lines, configured so that the successive application of the method according to the invention on the different assembly lines ultimately leads to the assembly of a complete product or a particular model A, B, . . . of a complete product, or else a portion of a product or a model A, B, . . . of a product.

The movable platform is then sufficient to ensure conveying the parts to be assembled from an assembly station to an assembly station within the same assembly line, and from an assembly line to an assembly line, until the assembly of a complete product or a particular model A, B, . . . of a complete product, or else a portion of a product or a model A, B, . . . of a product. Nonetheless, a reloading of the movable platform may be necessary for the passage from an assembly line to the next assembly line.

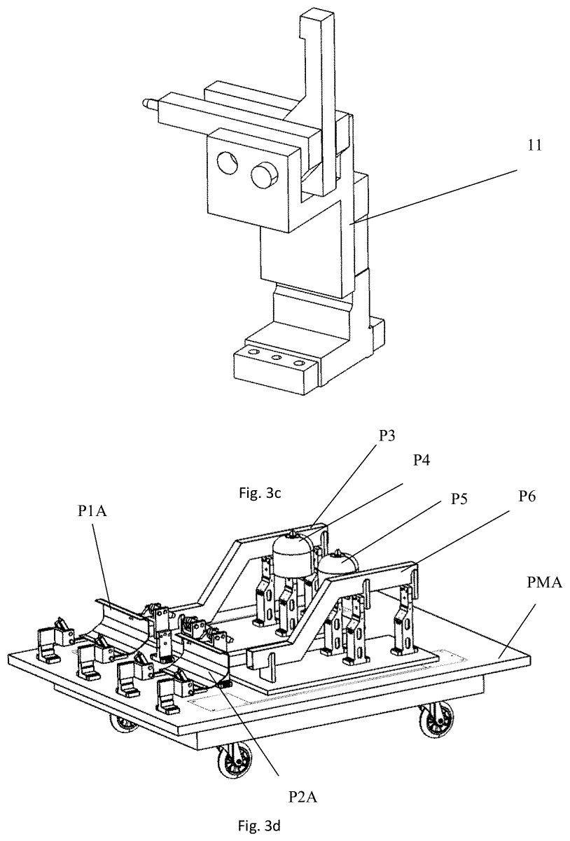

FIG. 4 illustrates the method according to the invention implemented on an assembly site SA composed by several assembly lines, for example 2 assembly lines LA1, LA2 in the represented example, and a series of movable platforms PMA, PMB, . . . These movable platforms follow each other along a circuit C in the direction indicated by the arrow. The circuit begins with an empty movable platform positioned on an area a0 on which step a0 of configuring the empty movable platform PMA, PMB, . . . takes place. This step a0 is followed by a step of manual or automatic loading, for example by one or several robot(s), then a step al of checking up the loading, until reaching the assembly stations S1, S2, S3, . . . of the assembly line LA1. On completion of the method according to the invention, implemented according to steps b) to f) on the different stations S1, S2, S3 of the assembly line LA1, the movable platform PMA, PMB, . . . then goes to step ab of manual or automatic configuration and reloading, for example by one or several robot(s), where necessary, before proceeding to the next assembly line LA2 on which steps b) to f) will be repeated at the different assembly stations S1, S2 of this assembly line LA2.

Thanks to these arrangement, the logistics management of the flows of parts to be assembled throughout the lockers and other conveying lines of the prior art is simplified with the method according to the invention since the management of this flow only relies on a series of reconfigurable movable platforms between the assembly lines. It should be noted in particular that with the method according to the invention, it is no longer necessary to manage the coherence, between the different lockers, of the stacks of different parts, intended for assembling different models of the same product. With the method according to the invention, one single movable platform PMA, PMB, . . . , ensures the assembly of a product or a model of a product, where necessary throughout several assembly lines; a series of movable platforms PMA, PMB, . . . , ensures the assembly of several different models A, B, . . . of a product, where necessary throughout several assembly lines. As previously described, the platform may also be equipped for example with a memory system accessible in reading and writing allowing memorizing and identifying the nature of the product to be assembled on the platform as well as progress information on the assembly and/or qualitative check-up steps.

According to one aspect of the invention, the movable platform PM may be automated so as to be displaced in an unmanned fashion from an assembly station to the next one and from an assembly line to the next one.

According to another aspect of the invention, the movable platform may be configured so as to perform simple assembly operations, for example, welding, gluing, etc., directly on the platform, without it being necessary to transfer the concerned objects on an assembly station.

According to another aspect of the invention, the movable platform PM is equipped with handling robots which allows automating the transfer of the parts, and/or partial assemblies and/or intermediate assemblies from the movable platform PM to the station S1, and from the station Si to the movable platform PM.

1. A method for assembling a product or a portion of a product, on an assembly site-(SA), comprising an assembly line (LA), the assembly line comprising a plurality of assembly stations (S1, S2, S3, . . . ) and at least one movable platform (PMA, PMB, . . . ), the method comprising the following steps applied to each movable platform of the at least one movable platform (PMA, PMB, . . . ):
a) Loading on the movable platform (PMA, PMB, . . . ) a plurality of objects, comprising one or several elementary part(s) (P1A, P2A, P3A, P4, P5, P6 . . . ) and/or one or several partial assembly(assemblies) (AP1, AP2, . . . APi) constituting the product to be assembled or a portion of the product to be assembled on the assembly line (LA),
b) Displacing the movable platform (PMA, PMB, . . . ) up to an assembly station of the plurality of assembly stations (S1, S2, S3, . . . ) of the assembly line (LA);
c) transferring on the assembly station one or several object(s) of the plurality of objects present on the movable platform (PMA, PMB, . . . );
d) modifying, or assembling the object(s) transferred at step c), so as to constitute an intermediate object;
e) transferring on the movable platform (PMA, PMB, . . . ) the intermediate object constituted at the previous step, such that, for the following steps of the method, the object or said several objects transferred at step c) are replaced in the plurality of objects by the intermediate object constituted at step d);
f) repeating steps b) to e) so that the platform is successively displaced from an assembly station, where an intermediate object is constituted, to another station, where another intermediate object is constituted.

2. The assembly method according to claim 1, wherein step a) is preceded by a step a0) of configuring each movable platform of the at least one movable platform (PMA, PMB, . . . ).

3. The assembly method according to claim 1, wherein step a) is followed by a step a1) of automated check-up of the loading of each movable platform of the at least one movable platform (PMA, PMB, . . . ).

4. The assembly method according to claim 1, wherein the assembly site (SA) comprises a plurality of assembly lines (LA, . . . , LAi), each dedicated to the assembly of one or several partial assembly(assemblies) (AP, AP1, AP2, . . . APi) of the product or a portion of a product, the method comprising the following additional steps, carried out before step b):
aa) displacing a movable platform (PMA, PMB, . . . ) from the at least one movable platform up to an assembly line (LA) of the plurality of assembly lines (LA, . . . , LAi, . . . );
ab) checking up the loading of the movable platform (PMA, PMB, . . . ) and, depending on the result of this check-up, configuring the movable platform (PMA, PMB, . . . ) and completing the loading present on the movable platform (PMA, PMB, . . . ) such that it carries a plurality of objects, constituting the product to be assembled or the portion of the product to be assembled on the assembly line (LA)
and the method comprising the following additional step, carried out following step f):
g) repeating steps aa), ab), b) to f) so that the movable platform is successively displaced from an assembly line (LA) on which at least one partial assembly (AP1, AP2, . . . APi) is assembled to another assembly line (LAi) on which another partial assembly (AP1, AP2, . . . APi) is assembled.

5. The assembly method according to claim 1, wherein the at least one movable platform is displaced by an autonomous vehicle driven by a programmed system.

6. The assembly method according to claim 1, wherein the at least one movable platform carries at least one handling robot to carry out at least one portion of steps a), and/or c), and/or e) of the method.

7. The assembly method according to claim 1, wherein the at least one movable platform (PMA, PMB, . . . ) comprises an electronic memory, accessible in writing and reading successively by each assembly station of the plurality of assembly stations (S1, S2, S3, . . . ), said electronic memory containing information relating to the product or to the portion of a product to be assembled and/or to the objects of the plurality of objects loaded on the at least one movable platform, said information being updated and used by each assembly station of the plurality of assembly stations (S1, S2, S3, . . . ).

8. The assembly method according to claim 1, wherein the assembled product is a motor vehicle or a portion of a motor vehicle.

9. The assembly method according to claim 2, wherein step a) is followed by a step a1) of automated check-up of the loading of each movable platform of the at least one movable platform (PMA, PMB, . . . ).

10. The assembly method according to claim 2, wherein the assembly site (SA) comprises a plurality of assembly lines (LA, . . . , LAi), each dedicated to the assembly of one or several partial assembly(assemblies) (AP, AP1, AP2, . . . APi) of the product or a portion of a product, the method comprising the following additional steps, carried out before step b):
aa) displacing a movable platform (PMA, PMB, . . . ) from the at least one movable platform up to an assembly line (LA) of the plurality of assembly lines (LA, . . . , LAi, . . . );
ab) checking up the loading of the movable platform (PMA, PMB, . . . ) and, depending on the result of this check-up, configuring the movable platform (PMA, PMB, . . . ) and completing the loading present on the movable platform (PMA, PMB, . . . ) such that it carries a plurality of objects, constituting the product to be assembled or the portion of the product to be assembled on the assembly line (LA)
and the method comprising the following additional step, carried out following step f):
g) repeating steps aa), ab), b) to f) so that the movable platform is successively displaced from an assembly line (LA) on which at least one partial assembly (AP1, AP2, . . . APi) is assembled to another assembly line (LAi) on which another partial assembly (AP1, AP2, . . . APi) is assembled.

11. The assembly method according to claim 3, wherein the assembly site (SA) comprises a plurality of assembly lines (LA, . . . , LAi), each dedicated to the assembly of one or several partial assembly(assemblies) (AP, AP1, AP2, . . . APi) of the product or a portion of a product, the method comprising the following additional steps, carried out before step b):
aa) displacing a movable platform (PMA, PMB, . . . ) from the at least one movable platform up to an assembly line (LA) of the plurality of assembly lines (LA, . . . , LAi, . . . );
ab) checking up the loading of the movable platform (PMA, PMB, . . . ) and, depending on the result of this check-up, configuring the movable platform (PMA, PMB, . . . ) and completing the loading present on the movable platform (PMA, PMB, . . . ) such that it carries a plurality of objects, constituting the product to be assembled or the portion of the product to be assembled on the assembly line (LA)
and the method comprising the following additional step, carried out following step f):
g) repeating steps aa), ab), b) to f) so that the movable platform is successively displaced from an assembly line (LA) on which at least one partial assembly (AP1, AP2, . . . APi) is assembled to another assembly line (LAi) on which another partial assembly (AP1, AP2, . . . APi) is assembled.

12. The assembly method according to claim 9, wherein the assembly site (SA) comprises a plurality of assembly lines (LA, . . . , LAi), each dedicated to the assembly of one or several partial assembly(assemblies) (AP, AP1, AP2, . . . APi) of the product or a portion of a product, the method comprising the following additional steps, carried out before step b):
aa) displacing a movable platform (PMA, PMB, . . . ) from the at least one movable platform up to an assembly line (LA) of the plurality of assembly lines (LA, . . . , LAi, . . . );
ab) checking up the loading of the movable platform (PMA, PMB, . . . ) and, depending on the result of this check-up, configuring the movable platform (PMA, PMB, . . . ) and completing the loading present on the movable platform (PMA, PMB, . . . ) such that it carries a plurality of objects, constituting the product to be assembled or the portion of the product to be assembled on the assembly line (LA)
and the method comprising the following additional step, carried out following step f):
g) repeating steps aa), ab), b) to f) so that the movable platform is successively displaced from an assembly line (LA) on which at least one partial assembly (AP1, AP2, . . . APi) is assembled to another assembly line (LAi) on which another partial assembly (AP1, AP2, . . . APi) is assembled.

13. The assembly method according to claim 2, wherein the at least one movable platform is displaced by an autonomous vehicle driven by a programmed system.

14. The assembly method according to claim 3, wherein the at least one movable platform is displaced by an autonomous vehicle driven by a programmed system.

15. The assembly method according to claim 4, wherein the at least one movable platform is displaced by an autonomous vehicle driven by a programmed system.

16. The assembly method according to claim 12, wherein the at least one movable platform is displaced by an autonomous vehicle driven by a programmed system.

17. The assembly method according to claim 2, wherein the at least one movable platform carries at least one handling robot to carry out at least one portion of steps a), and/or c), and/or e) of the method.

18. The assembly method according to claim 16, wherein the at least one movable platform carries at least one handling robot to carry out at least one portion of steps a), and/or c), and/or e) of the method.

19. The assembly method according to claim 18, wherein the at least one movable platform (PMA, PMB, . . . ) comprises an electronic memory, accessible in writing and reading successively by each assembly station of the plurality of assembly stations (S1, S2, S3, . . . ), said electronic memory containing information relating to the product or to the portion of a product to be assembled and/or to the objects of the plurality of objects loaded on the at least one movable platform, said information being updated and used by each assembly station of the plurality of assembly stations (S1, S2, S3, . . . ).

20. The assembly method according to claim 19, wherein the assembled product is a motor vehicle or a portion of a motor vehicle.
